(19) United States
(12) Patent Application Publication
(10) Pub. No.: US 2021/0352185 A1
(43) Pub. Date: Nov. 11, 2021

(54) INFORMATION PROCESSING APPARATUS AND CONTROL METHOD

(71) Applicant: CANON KABUSHIKI KAISHA, Tokyo (JP)

(72) Inventor: Yuki Futatsumori, Kanagawa (JP)

(21) Appl. No.: 17/243,667

(22) Filed: Apr. 29, 2021

(30) Foreign Application Priority Data
May 8, 2020 (JP) 2020-082443

(51) Int. Cl. H04N 1/00; G06F 1/3206; G06F 3/12

(52) U.S. Cl. CPC H04N 1/00891; H04N 1/00904; G06F 3/1268; G06F 3/1221; G06F 1/3206

(57) ABSTRACT

In order to turn on power of an information processing apparatus at an appropriate timing. For this purpose, the information processing apparatus includes a manually power-on function of turning on the power in a case where a mechanical power supply switch is turned on and an automatically power-on function of turning on the power in a case where predetermined information is detected. In a case where the information processing apparatus is in a particular mode, the automatically power-on function is disabled.

### BACKGROUND OF THE INVENTION

### Field of the Invention

The present invention relates to an information processing apparatus and a control method.

### Description of the Related Art

There is an information processing apparatus capable of automatically switching from a power-off state to a power-on state in a case where a job or the like is input from an external device connected via a network or the like. Further, Japanese Patent Laid-Open No. 2010-166251 discloses an image printing apparatus capable of automatically switching between power-on and power-off based on a time and a period set by a user.

### SUMMARY OF THE INVENTION

In a case where an information processing apparatus is in a power-off state, a user sometimes performs an operation of maintenance processing or the like on the inside of the apparatus. In that case, in a case where the power of the information processing apparatus is automatically turned on, there is a possibility that a starting sequence cannot be normally performed or that the apparatus breaks down.

The present invention has been accomplished in order to solve the above-described problem. Accordingly, an object of the present invention is to turn on power to the information processing apparatus at an appropriate timing.

In a first aspect of the present invention, there is provided an information processing apparatus comprising: a first power-on unit configured to turn on power in a case where a power supply switch is turned on; a second power-on unit configured to turn on the power in a case where predetermined information is detected; and a control unit configured to control the first power-on unit and the second power-on unit; wherein in a case where the information processing apparatus is in a particular mode, the control unit disables the second power-on unit.

In a second aspect of the present invention, there is provided an information processing apparatus comprising: a power-on unit configured to turn on power in a case where a power supply switch is turned on and in a case where predetermined information is detected; and a control unit configured to control the power-on unit, wherein the control unit disables the predetermined information in a case where the information processing apparatus is in a particular mode.

In a third aspect of the present invention, there is provided a control method of an information processing apparatus comprising: turning on power in a case where a power supply switch is turned on; and turning on the power in a case where predetermined information is detected; wherein in a case where the information processing apparatus is in a particular mode, the power is not turned on even if the predetermined information is detected.

Further features of the present invention will become apparent from the following description of exemplary embodiments with reference to the attached drawings.

### BRIEF DESCRIPTION OF THE DRAWINGS

FIG. 1 is a perspective view of a printing apparatus;

FIG. 2 is a cross-sectional view for explaining a configuration of a printing unit of the printing apparatus;

FIG. 3 is a block diagram for explaining a configuration of control of the printing apparatus;

FIG. 4 is a flowchart for explaining a power-off sequence;

FIG. 5 is a flowchart of a disablement canceling sequence in a second embodiment; and

FIG. 6 is a flowchart of a disablement canceling sequence in a third embodiment.

### DESCRIPTION OF THE EMBODIMENTS

### First Embodiment

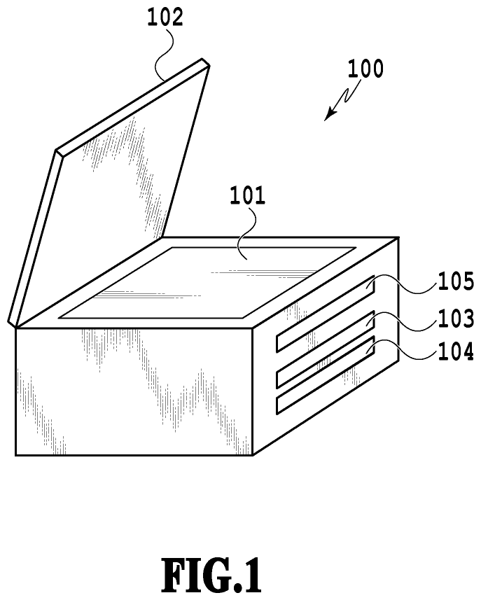

FIG. 1 is a perspective view of a printing apparatus 100 which can be used as an information processing apparatus of the present invention. The printing apparatus 100 of the present embodiment is a Multifunction Peripheral (MFP) including a reading unit (scanner) and a printing unit (printer).

A document plate 101 is a transparent vitreous plate and is used in placing a document thereon such that the document is read by the scanner. A document cover 102 is a cover to prevent light irradiated in performing reading by the scanner from leaking out to the outside.

Paper cassettes 103 and 104 are cassettes for accommodating a sheet before printing. A user can pull the paper cassettes 103 or 104 out of an apparatus body to accommodate and stack a plurality of sheets inside the paper cassette. The paper cassettes 103 and 104 may accommodate either the sheets of the same size or the same type or the sheets of different sizes or different types.

A discharge tray 105 is a tray for accommodating the sheet after the printing. The discharge tray 105 is pulled out to be used in a case where a printing operation is performed.

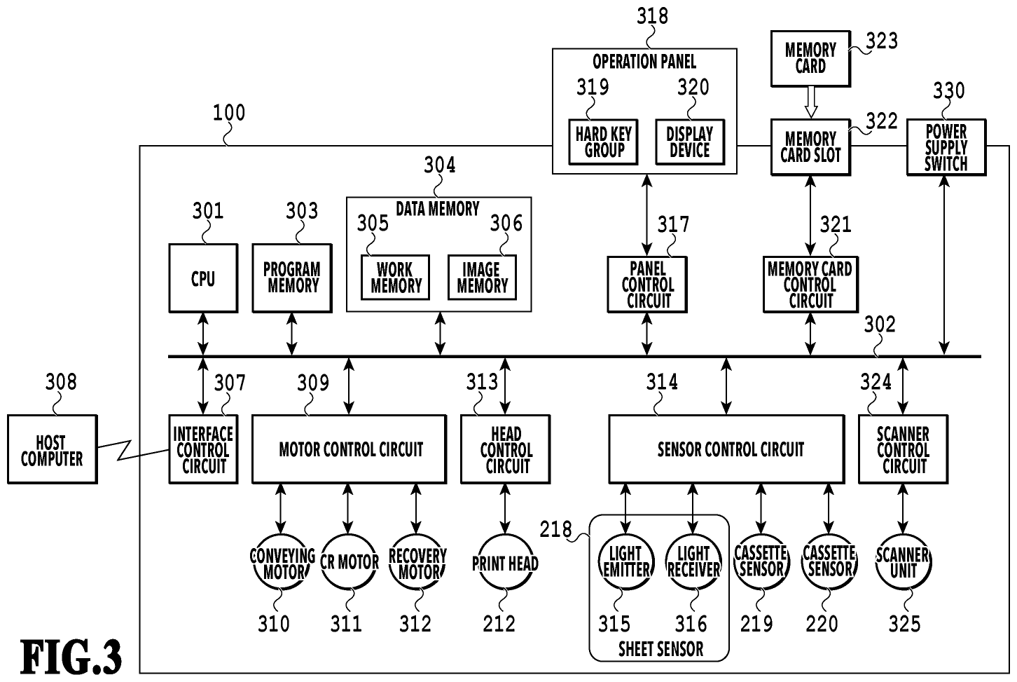

Incidentally, the outer surface of the printing apparatus 100 is also provided, for example, with an operation panel 318 for receiving an instruction from the user and for displaying information to the user and a memory card slot 322 capable of mounting a memory card. However, these members are not shown in FIG. 1 (see FIG. 3). The outer surface of the printing apparatus 100 is also provided with a power supply switch 330 for mechanically switching between power-on and power-off (see FIG. 3). In addition, there is provided at the backside of the apparatus a main body cover which can be opened or closed by the user at the time of performing maintenance processing inside the apparatus or exchanging a consumable such as ink.

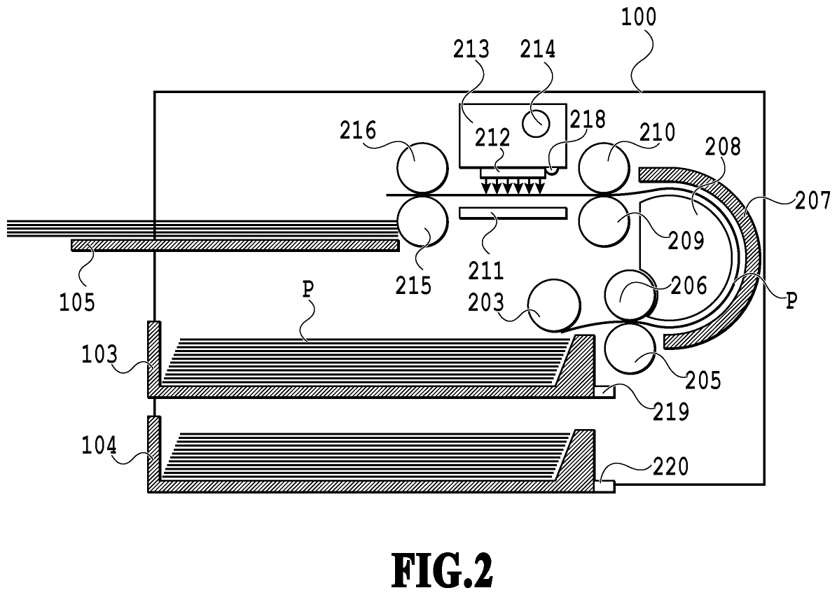

FIG. 2 is a cross-sectional view for explaining a configuration of the printing unit of the printing apparatus 100. Once a print job is input to the printing apparatus 100, a pickup roller 203 rotates to feed the top sheet P of the plurality of sheets accommodated in the paper cassette 103 to feeding rollers 205 and 206 in the figure. The feeding rollers 205 and 206 pinch the picked up sheet P to further feed it to the inside of the apparatus. After that, the sheet P is conveyed making a U-turn while being guided by paper guides 207 and 208 to be pinched by conveying rollers 209 and 210. Incidentally, the printing apparatus 100 is also provided with a pickup roller, feeding rollers and the like for feeding the sheet accommodated in the paper cassette 104 to the paper guides 207 and 208. However, these members are omitted in FIG. 2.

Located further downstream from the conveying rollers 209 and 210 is a printable area by a print head 212 and even further downstream from the printable area, there are arranged discharging rollers 215 and 216 for discharging the sheet P after the printing. In other words, one side of the sheet P in the printable area is pinched by the conveying rollers 209 and 210 and the other side is pinched by the discharging rollers 215 and 216 so as to maintain a smooth plane with respect to the print head 212. Further, the sheet P in the printable area is supported from below by a platen 211 made of a plate.

A carriage 213 with the print head 212 mounted thereon is capable of reciprocal movement along a guide shaft 214 in a vertical direction in the figure. An image corresponding to one band is printed on the sheet P by the carriage 213 moving and the print head 212 discharging ink according to print data. After such a print scan corresponding to one time is ended, the conveying rollers 209 and 210 and the discharging rollers 215 and 216 both rotate to convey the sheet by a distance corresponding to the above-described one band. By alternately repeating the print scan corresponding to the one band and a conveying operation of the sheet described above, the images are sequentially formed on the sheet P. After the final print scan is ended, the discharging rollers 215 and 216 continuously rotate to discharge the sheet P to the discharge tray 105.

The carriage 213 is provided with a sheet sensor 218 for detecting the front edge and the rear edge of the sheet P. The sheet sensor 218 is an optical sensor having a light emitter 315 and a light receiver 316 (see FIG. 3). Further, cassette sensors 219 and 220 for detecting mounting of the paper cassettes 103 and 104 are provided respectively at positions on which the front edges of the mounted paper cassettes 103 and 104 abut. The cassette sensors 219 and 220 may be configured, for example, with a photo-interruptor and a mechanical switch.

Incidentally, FIGS. 1 and 2 show, as an example, the printing apparatus 100 having the two paper cassettes 103 and 104. However, the number of paper cassettes may also be either only one or more than or equal to three.

FIG. 3 is a block diagram for explaining a configuration of control of the printing apparatus 100. A CPU 301 in the form of a microprocessor controls the entire apparatus connected via an internal bus 302 in accordance with, for example, programs stored in a program memory 303 in the form of a ROM and in a data memory 304 in the form of a RAM. The data memory 304 includes a work memory 305 used as a work area of the CPU 301 and an image memory 306 temporarily storing image data.

An interface control circuit 307 controls, under instructions from the CPU 301, transmission/reception of information to/from an externally connected host computer 308. Even though FIG. 3 shows a state in which the interface control circuit 307 is connected to the one host computer 308, the printing apparatus 100 is capable of being connected to a plurality of host computers through a network or a different interface. This means that it is possible for the printing apparatus 100 to receive the print jobs or read jobs from the plurality of host computers and perform operations according to these jobs. Other examples of the host computer 308 may be a smart phone and a digital camera as well as a personal computer.

A motor control circuit 309 controls, under instructions from the CPU 301, a conveying motor 310, a CR motor 311, and a recovery motor 312. The conveying motor 310 is a driving motor for rotating the pickup roller 203, the feeding rollers 205 and 206, the conveying rollers 209 and 210, and the discharging rollers 215 and 216. The CR motor 311 is a driving motor for the reciprocal movement of the carriage 213. The recovery motor 312 is a driving motor for causing a recovery mechanism, which is not shown in the figure, to perform recovery processing including a suction operation on the print head 212.

A head control circuit 313 controls, under instructions from the CPU 301, a discharging operation of the print head 212.

A sensor control circuit 314 controls, under instructions from the CPU 301, various sensors arranged within the apparatus. For example, the sensor control circuit 314 controls the amount of light emitted by the light emitter 315 in the sheet sensor 218 and detects voltage output from the light receiver 316. Further, the sensor control circuit 314 transmits to the CPU 301 the detection values of the cassette sensors 219 and 220. The CPU 301 can determine, based on the received detection values, whether each of the paper cassettes 103 and 104 is mounted. In addition, the sensor control circuit 314 transmits to the CPU 301 the detection value of a cover sensor 340 of detecting whether the main body cover is open or closed. Incidentally, although the following sensors are not shown in FIG. 3, even more sensors such as a sensor for detecting the rotating positions of the conveying rollers 209 and 210 and a sensor for detecting the moving position of the carriage 213 may be provided within the apparatus. The CPU 301 can recognize the state of the printing apparatus 100 based on the detection values received from the sensors.

A panel control circuit 317 controls, under instructions from the CPU 301, the operation panel 318 provided on the external surface of the printing apparatus 100. There are arranged, on the operation panel 318, a hard key group 319 for accepting instructions from the user and a display device 320 for displaying information to the user.

A scanner control circuit 324 controls, under instructions from the CPU 301, read processing by a scanner 325. For example, the scanner control circuit 324 scans the document placed on the document plate 101 using a read head, obtains the image data, and stores the obtained image data in the image memory 306.

Under instructions from the CPU 301, a memory card control circuit 321 can read information from a memory card 323 mounted in the memory card slot 322 and write information to the memory card 323.

A power switch 330 is a mechanical switch capable of switching between power-on and power-off of the printing apparatus 100 by the user's pushing down the power switch. The CPU 301 is notified of switching information about the power switch 330 via the internal bus 302.

Under the above-mentioned configurations, in a case where, for example, the print job is transmitted from the host computer 308, the CPU 301 stores the image data included in the print job in the image memory 306 to perform predetermined image processing according to the program stored in the program memory 303. Then, the CPU 301 drives the print head 212 and various motors based on the generated print data to print an image on the sheet P.

Additionally, in a case where, for example, the read job is transmitted from the host computer 308, the CPU 301 drives the scanner 325 according to the read job and stores the obtained image data in the image memory 306 temporarily. The CPU 301 then, according to the read job, transmits to the host computer 308 or writes to the memory card 323 the image data temporarily stored. Further, in a case where the received job is a copy command, the CPU 301 subjects the image data temporarily stored in the image memory 306 to predetermined image processing and prints an image on the sheet P based on the generated print data.

In the present embodiment, the CPU 301 controls turning-on of power of the printing apparatus 100 based on, for example, the switching information from the power supply switch 330, job input from the device connected externally such as the host computer 308, and a scheduled time for power-on or power-off. In other words, the CPU 301 has a manually power-on function of turning the power on in a case where the power supply switch 330 is turned on and an automatically power-on function of turning the power on in a case where predetermined information such as a job from the external device or the power-on time is detected.

Incidentally, in the case of the printing apparatus 100 in the power-off state, the user sometimes performs, on the inside of the apparatus, an operation such as the maintenance processing. In such a case, there is a possibility that a starting sequence cannot be normally performed or that the apparatus breaks down in a case where the printing apparatus 100 is automatically powered on during the operation. Thus, a power-off sequence to be described below is performed in the present embodiment in order to avoid such a situation.

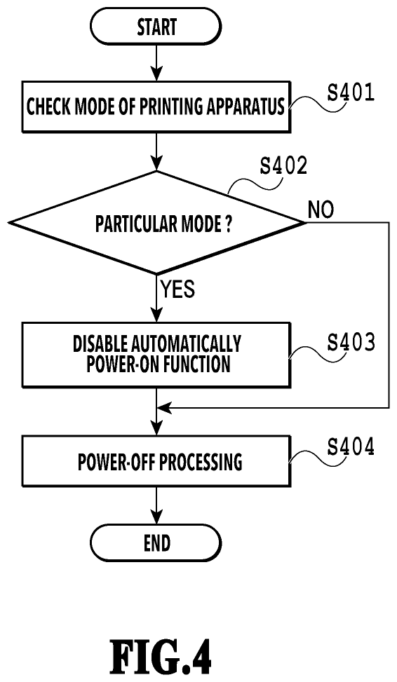

FIG. 4 is a flowchart for explaining the power-off sequence of the present embodiment. The present processing starts in the case of turning off the power supply switch 330 and is performed by the CPU 301.

Once the present processing starts, the CPU 301 first checks, in S401, the mode of the printing apparatus 100. In S402, the CPU 301 determines whether the apparatus is in a particular mode.

The particular mode will be described below. The particular mode is a mode for performing some operation on the inside of the apparatus by the user, for example, cleaning of the conveying rollers 209 and 210. It is assumed that the particular mode of the present embodiment is basically a mode which is selected from the operation panel 318 by the user to conduct work according to display of the operation panel. Accordingly, the CPU 301 can determine whether the apparatus is in the particular mode based on the state of the apparatus in turning off the power. The CPU 301 may also determine whether the apparatus is in the particular mode based on, for example, the detection values of the sensors such as the cover sensor 340.

In the case of determining in S402 that the apparatus is not in the particular mode, the CPU 301 proceeds to S404 to perform power-off processing of the apparatus. On the other hand, in the case of determining in S402 that the apparatus is in the particular mode, the CPU 301 proceeds to S403 to disable the automatically power-on function and then performs the power-off processing of the apparatus in S404. This is the end of the present processing.

According to the present embodiment, in a case where the power is turned off with the automatically power-on function being disabled in S403, the power of the printing apparatus 100 is not automatically turned on even in a case where the job is input from the external device afterward or in a case where the pre-scheduled time for power-on is confirmed.

That is, according to the present embodiment, at the time of performing some operation on the inside of the apparatus by the user, the printing apparatus is not turned on and turning on the power at an appropriate timing is possible.

### Second Embodiment

The power-off sequence described in the first embodiment is performed also in the present embodiment. In addition, descriptions will be given of a method of canceling disablement of the automatically power-on function in the present embodiment. More specifically, this is the method in which the disablement of the automatically power-on function is canceled to cause the printing apparatus 100 to come back to an ordinary mode in the case of the user's turning on the power supply switch 330 of the printing apparatus 100.

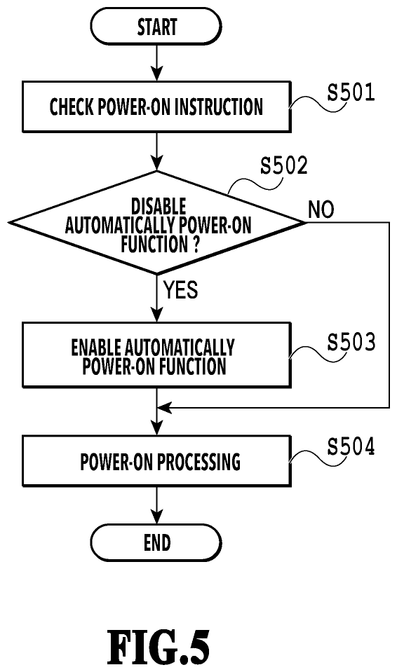

FIG. 5 is a flowchart for explaining a disablement canceling sequence of the present embodiment. The present processing starts by the CPU 301 when the power supply switch 330 of the printing apparatus 100 is turned on. Upon start of the present processing, the CPU 301 first checks in S501 that the power is turned on according to an instruction from the power supply switch 330. In S502, the CPU 301 determines whether the automatically power-on function has been disabled. In the case of determining that the automatically power-on function has not been disabled, which means that the automatically power-on function is enabled, the CPU 301 skips S503 and proceeds to S504 to perform power-on processing of the apparatus. On the other hand, in the case of determining in S502 that the automatically power-on function has been disabled, the CPU 301 enables the automatically power-on function in S503, and then performs the power-on processing of the apparatus in S504. This is the end of the present processing.

According to such a sequence of the present embodiment, it is possible to cause the printing apparatus 100 to come back to the ordinary mode by the user's turning on the power supply switch 330 of the printing apparatus 100 after he/she has completed a predetermined operation such as the maintenance processing.

### Third Embodiment

Similarly to a second embodiment, descriptions will be given of a method of enabling the disabled automatically power-on function also in the present embodiment. However, in the present embodiment, a method of automatically enabling the automatically power-on function at an appropriate timing will be described.

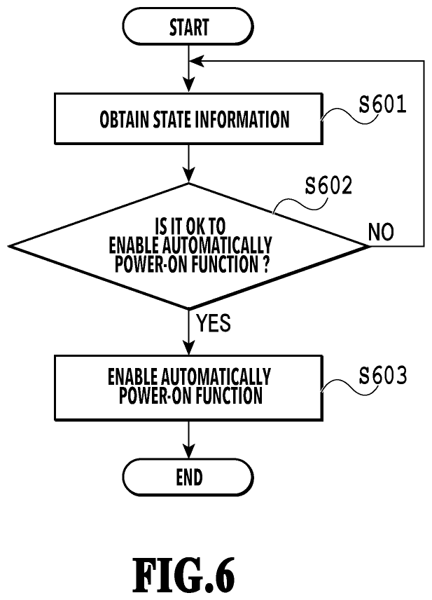

FIG. 6 is a flowchart for explaining a sequence of enabling the automatically power-on function in the present embodiment. The present processing is performed by the CPU 301 at the appropriate timing after the power of the printing apparatus 100 has been turned off with the automatically power-on function being disabled.

Once the present processing starts, the CPU 301 obtains, in S601, state information on the apparatus. The state information is information which indicates whether each mechanism of the apparatus is in a given state at a given position. The state information includes detection information on the cover sensor 340 for example.

In S602, the CPU 301 determines, based on the obtained state information, whether it is all right to enable the automatically power-on function of the printing apparatus 100. For example, in a case where the mechanism in the apparatus is not in the given state including a case where the rotation stop positions of the conveying rollers 209 and 210 are not in an initial position and a case where the main body cover is open, there is a high possibility that the user is performing the maintenance operation or the like on the inside of the apparatus. Thus, in such a case, the CPU 301 determines that the automatically power-on function should not be enabled under present circumstances and returns to S601. In contrast, in a case where the mechanism in the apparatus is in the given state at the given position, there is a high possibility that the maintenance operation by the user has been completed. Thus, in such a case, the CPU 301 determines in S602 that it is all right to enable the automatically power-on function and proceeds to S603. The CPU 301 then enables, in S603, the automatically power-on function and end the present processing.

According to the above-mentioned embodiment, in a case where the user performs the operation of maintenance processing or the like with the power turned off, a step S601 and a step S602 are repeatedly performed to maintain the automatically power-on function in the disabled state. Thus, the power of the printing apparatus 100 is not automatically turned on even in a case where the print job is input from the external device or in a case where the pre-scheduled time for power-on is confirmed and this makes it possible to suppress a breakdown which comes with unexpected activation.

On the other hand, in a case where the maintenance processing has ended and the user closes the main body cover with each member of the apparatus at the given position, the CPU 301 determines in S602 that an answer is YES to enable the automatically power-on function in S603. Thus, in a case where the job is input from the external device or in a case where the pre-scheduled time for power-on is confirmed, the power of the apparatus is automatically turned on afterward to make it possible to perform print processing or the read processing in accordance with the job.

This means that, according to the present embodiment, it is possible to enable the automatically power-on function at the appropriate timing without the user's switching the power supply switch 330 as in the second embodiment, whereby the power can be turned on at the appropriate timing.

Please be noted that in FIG. 6, the processing is ended by enabling the automatically power-on function in S603. However, another step of turning on the power may also be added subsequent to S603.

### OTHER EMBODIMENTS

A configuration of switching between enablement and disablement of the automatically power-on function is used in the embodiments described above. However, advantageous results similar to those of the above-described embodiments can also be obtained, for example, by preparing a flag which disables power-on based on the job from the device externally connected or a schedule function. In that case, the CPU 301 may set the flag in S403 to perform the power-off processing in S404 in the case of determining in S402 in FIG. 4 that the apparatus is currently in the particular mode. In addition, in a case where the flag described above is set, even if the job is received from the device externally connected or the pre-scheduled time for power-on is confirmed, these matters may simply be disabled.

Descriptions have been given above with the MFP including the scanner and the printer as an example and further the above-described embodiments are also applicable to other information processing apparatuses. In any case, advantageous results similar to those of the above-described embodiments can be obtained as long as the information processing apparatuses have the automatically power-on function of automatically turning on the power of the apparatus in the case of detecting predetermined information.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-082443, filed May 8, 2020, which is hereby incorporated by reference wherein in its entirety.

What is claimed is:

1. An information processing apparatus comprising:
a first power-on unit configured to turn on power in a case where a power supply switch is turned on;
a second power-on unit configured to turn on the power in a case where predetermined information is detected; and
a control unit configured to control the first power-on unit and the second power-on unit;
wherein in a case where the information processing apparatus is in a particular mode, the control unit disables the second power-on unit.

2. The information processing apparatus according to claim 1, wherein the predetermined information comprises information indicating that a job has been input from an external device or information indicating that a pre-scheduled time for power-on has come.

3. The information processing apparatus according to claim 1, wherein the particular mode is a mode in which a user can perform an operation on an inside of the information processing apparatus with the power turned off.

4. The information processing apparatus according to claim 3, wherein the control unit determines, based on a state of the information processing apparatus at the time of the power being turned off, whether the information processing apparatus is in the particular mode.

5. The information processing apparatus according to claim 3, wherein the control unit determines, based on detection values of a plurality of sensors provided for the information processing apparatus, whether the information processing apparatus is in the particular mode.

6. The information processing apparatus according to claim 1, wherein the control unit cancels disablement of the second power-on unit in a case where the power supply switch is turned on.

7. The information processing apparatus according to claim 1, wherein the control unit cancels disablement of the second power-on unit in a case where it is confirmed that a mechanism of the information processing apparatus is in a given state in turning off the power of the information processing apparatus.

8. The information processing apparatus according to claim 1, further comprising:
a generation unit configured to generate print data based on a job received from an external device;
a print unit configured to print an image on a sheet according to the print data; and
a conveyance unit configured to convey the sheet.

9. The information processing apparatus according to claim 8, wherein the particular mode is a mode in which a user performs maintenance on the conveyance unit.

10. An information processing apparatus comprising:
a power-on unit configured to turn on power in a case where a power supply switch is turned on and in a case where predetermined information is detected; and
a control unit configured to control the power-on unit,
wherein the control unit disables the predetermined information in a case where the information processing apparatus is in a particular mode.

11. A control method of an information processing apparatus comprising:
turning on power in a case where a power supply switch is turned on; and
turning on the power in a case where predetermined information is detected;
wherein in a case where the information processing apparatus is in a particular mode, the power is not turned on even if the predetermined information is detected.
